(19) United States
(12) Patent Application Publication
(10) Pub. No.: US 2011/0235223 A1
(43) Pub. Date: Sep. 29, 2011

(54) CIRCUIT PROTECTION SYSTEM

(76) Inventors: Tsung-Hsun Wu, Taoyuan County (TW); Wei-Chun Chang, New Taipei City (TW); Chien-Wei Sung, Taoyuan County (TW)

(21) Appl. No.: 13/050,963

(22) Filed: Mar. 18, 2011

(30) Foreign Application Priority Data
Mar. 23, 2010 (TW) 099108476

(51) Int. Cl. H02H 9/00

(52) U.S. Cl. 361/56

(57) ABSTRACT

A circuit protection system, which is coupled to an input end of an integrated circuit receiving an input signal from a signal source, includes an electrostatic discharge protection element and a leakage current protection circuit. The leakage current protection circuit includes a first filter capacitor coupled to the electrostatic discharge protection element, wherein when the input signal includes leakage current with an ac component, the first filter capacitor behaves as a high impedance unit for preventing the leakage current from passing through the electrostatic discharge protection component, and when the input signal includes static electricity, the first filter capacitor behaves as a low impedance unit for allowing the input signal to pass through the electrostatic discharge protection element.

### BACKGROUND OF THE INVENTION

1. Field of the Invention

The present invention relates to a circuit protection system, and more particularly, to a circuit protection system capable of preventing an integrated circuit from being damaged by a leakage current generated by an AC power source.

2. Description of the Prior Art

Please refer to FIG. 1, which is a diagram showing an electrostatic discharge protection element 100 of the prior art. The electrostatic discharge protection element 100 is utilized for preventing an integrated circuit 101 from being damaged by static electricity. The electrostatic discharge protection element 100 is coupled to an input end Pᵢₙ of the integrated circuit 101. The input end Pᵢₙ receives an input signal from a signal source Sᵢₙ. The electrostatic discharge protection element 100 comprises Zener diodes ZD₁ and ZD₁. A first end of the Zener diode ZD₁ is coupled to the input end Pᵢₙ. A second end of the Zener diode ZD₁ is coupled to a second end of the Zener diode ZD₂. A first end of the Zener diode ZD₂ is coupled to a ground end. When the input signal comprises static electricity, the static electricity causes the Zener diode ZD₁ to conduct in reverse due to its high potential. Therefore, the electrostatic discharge protection element 100 conducts the static electricity to the ground end via the Zener diodes ZD₁ and ZD₂ in order to prevent the integrated circuit 101 from being damaged by the static electricity.

However, besides the static electricity, the signal source Sᵢₙ may also experience interference from leakage current I_{LEAK} generated by an AC power source V_{AC}. When the input signal comprises the leakage current I_{LEAK} having a frequency corresponding to a frequency of the AC power source V_{AC}, the input signal passes through the electrostatic discharge protection element 100 to the ground end due to its high potential. The electrostatic discharge protection element 100 is damaged because the current magnitude of the leakage current I_{LEAK} exceeds the limit that the electrostatic discharge protection element 100 can handle. Therefore, the electrostatic discharge protection element 100 can no longer protect the integrated circuit 101 if further static electricity is inputted to the input end Pᵢₙ.

### SUMMARY OF THE INVENTION

It is therefore an objective of the claimed invention to provide a circuit protection system in order to solve the problems of the prior art.

The present invention provides a circuit protection system, which is coupled to an input end of an integrated circuit receiving an input signal from a signal source, comprising an electrostatic discharge protection element and a leakage current protection circuit. The leakage current protection circuit comprises a first filter capacitor coupled to the electrostatic discharge protection element, wherein when the input signal comprises leakage current with an ac component, the first filter capacitor behaves as a high impedance unit for preventing the leakage current from passing through the electrostatic discharge protection component, and when the input signal comprises static electricity, the first filter capacitor behaves as a low impedance unit for allowing the input signal to pass through the electrostatic discharge protection element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an electrostatic discharge protection element of the prior art.

FIG. 2 is a diagram showing a circuit protection system of a first embodiment of the present invention.

FIG. 3 is a diagram showing a circuit protection system of a second embodiment of the present invention.

FIG. 4 is a diagram showing a circuit protection system of a third embodiment of the present invention.

FIG. 5 is a diagram showing a circuit protection system of a fourth embodiment of the present invention.

FIG. 6 is a diagram showing a circuit protection system of a fifth embodiment of the present invention.

FIG. 7 is a diagram showing a D-sub connector utilizing the circuit protection systems of the present invention.

### DETAILED DESCRIPTION

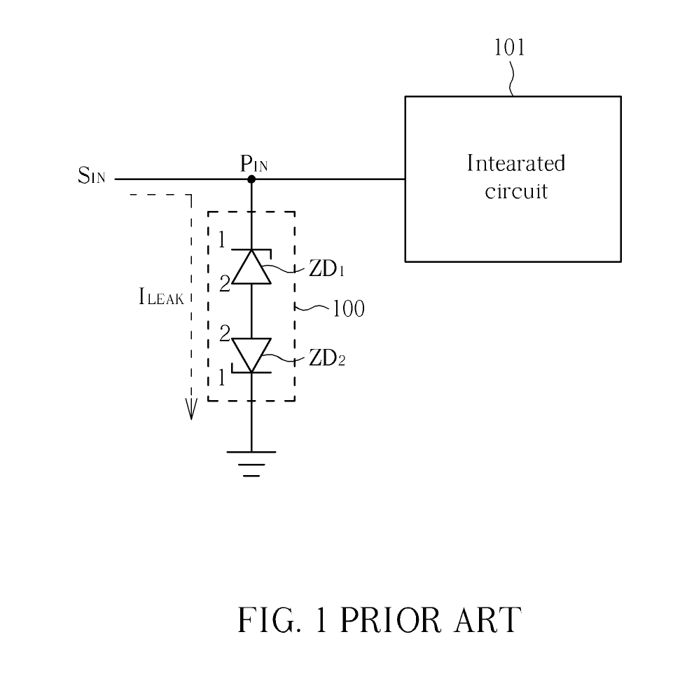

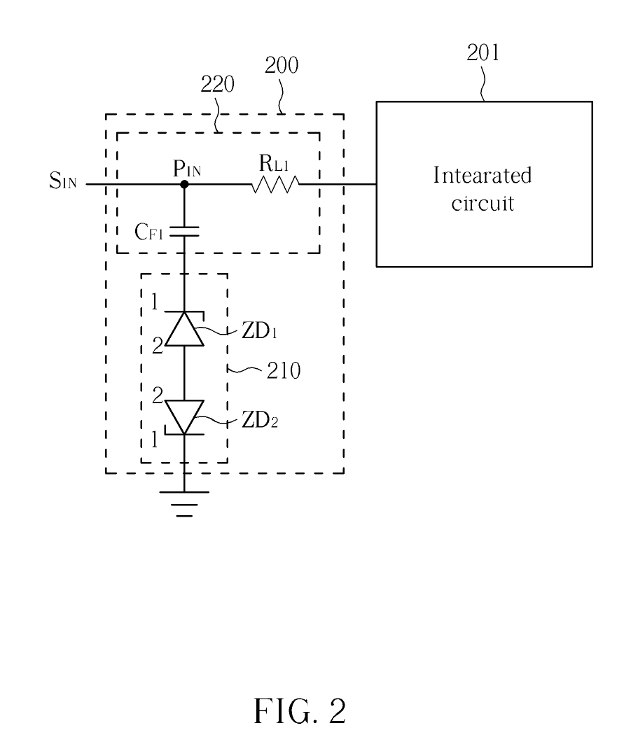

Please refer to FIG. 2, which is a diagram showing a circuit protection system 200 of a first embodiment of the present invention. The circuit protection system 200 comprises an electrostatic discharge protection element 210 and a leakage current protection circuit 220. The electrostatic discharge protection element 210 is utilized for preventing an integrated circuit 201 from being damaged by static electricity. The electrostatic discharge protection element 210 is coupled to an input end Pᵢₙ of the integrated circuit 201. The input end Pᵢₙ receives input signal from the signal source Sᵢₙ. The electrostatic discharge protection element 210 comprises Zener diodes ZD₁ and ZD₁. The electrostatic discharge protection element 210 of FIG. 2 is similar to the electrostatic discharge protection element 100 of FIG. 1, therefore functions of the electrostatic discharge protection element 210 are not explained further. The electrostatic discharge protection element 210 may be replaced by other types of electrostatic discharge protection elements. The leakage current protection circuit 220 comprises a first filter capacitor C_{F1}, and a current limiting resistor R_{L1}. The first filter capacitor C_{F1} is coupled between the electrostatic discharge protection element 210 and the input end Pᵢₙ. Generally, the impedance of a filter capacitor can be expressed by the following equation:

Z=1/(j×2×π×f×C) (1);

wherein Z represents the impedance, j represents an imaginary number, π represents the circular constant, f represents a frequency of a signal passing through the filter capacitor, and C represents the capacitance of the filter capacitor. Therefore, according to equation (1), the filter capacitor C_{F1} has lower impedance when the signal passing through the filter capacitor C_{F1} has higher frequency; and, the filter capacitor C_{F1} has higher impedance when the signal passing through the filter capacitor C_{F1} has lower frequency. As shown in FIG. 2, the signal source Sᵢₙ may experience interference from static electricity and leakage current I_{LEAK} generated from an AC power source V_{AC}. The frequency of the static electricity is higher than 300 MHz, and the frequency of the AC power source V_{AC} is around 60 Hz, which is much lower than the frequency of the static electricity. Therefore, the capacitance of the filter capacitor C_{F1} can be selected properly according to the input impedance of the current limiting resistor R_{L1} and the integrated circuit 201 such that the filter capacitor C_{F1} behaves as a high impedance unit when the input signal comprises the leakage current with an AC component corresponding to the AC power source V_{AC}, and the filter capacitor C_{F1} behaves as a low impedance unit when the input signal comprises the static electricity. Thus, the filter capacitor C_{F1} can protect the electrostatic discharge protection element 210 by preventing the leakage current I_{LEAK} from passing through the electrostatic discharge protection component 210. Although the leakage current I_{LEAK} flows to the integrated circuit 201 from the input end Pᵢₙ, the current limiting resistor R_{L1} limits the current magnitude of the input signal to a certain range before the input signal flows into the integrated circuit 201. Therefore, the leakage current protection circuit 220 can also protect the integrated circuit 201 from the leakage current I_{LEAK}. When the input signal comprises the static electricity, the static electricity flows to the electrostatic discharge protection component 210 from the input end Pᵢₙ since the filter capacitor C_{F1} behaves as a low impedance unit at that time. The static electricity makes the Zener diode ZD₁ conduct in reverse due to its high potential. Therefore, the electrostatic discharge protection element 210 can conduct the static electricity to the ground end via the Zener diodes ZD₁ and ZD₂ for eliminating the static electricity. Generally, the capacitance of the filter capacitor C_{F1} can be set to between 0.5 μF and 4 μF. When the capacitance of the filter capacitor C_{F1} is between 1 μF and 2.2 μF, the filter capacitor C_{F1} provides better performance.

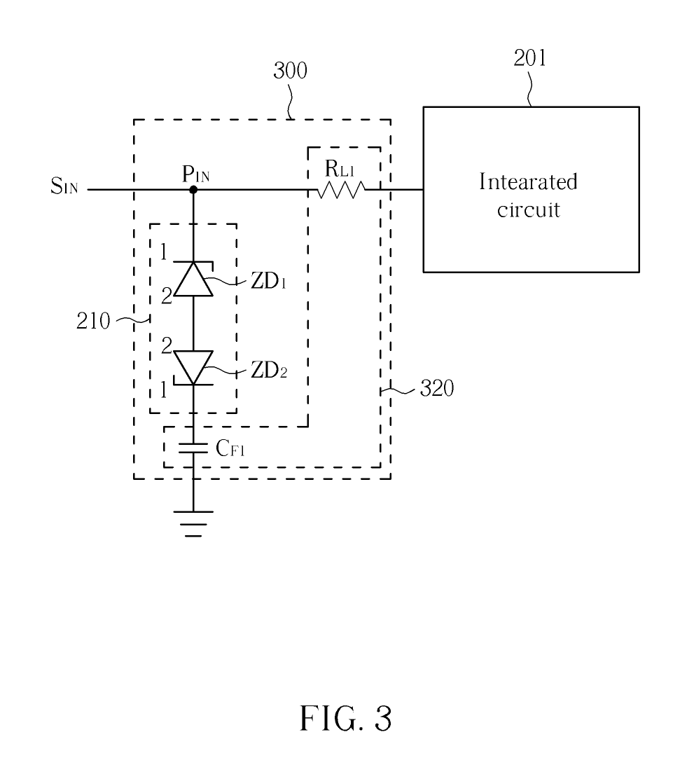

Please refer to FIG. 3, which is a diagram showing a circuit protection system 300 of a second embodiment of the present invention. The circuit protection system 300 comprises the electrostatic discharge protection element 210 and a leakage current protection circuit 320. In contrast to the leakage current protection circuit 220, the filter capacitor C_{F1} of the leakage current protection circuit 320 is coupled between the electrostatic discharge protection element 210 and the ground end. However, the filter capacitor C_{F1} is still on the electrostatic discharge path of the electrostatic discharge protection element 210, thus the filter capacitor C_{F1} retains the function described in FIG. 2. In addition, two filter capacitors may be included at both ends of the electrostatic discharge protection element 210, respectively, to achieve the above function.

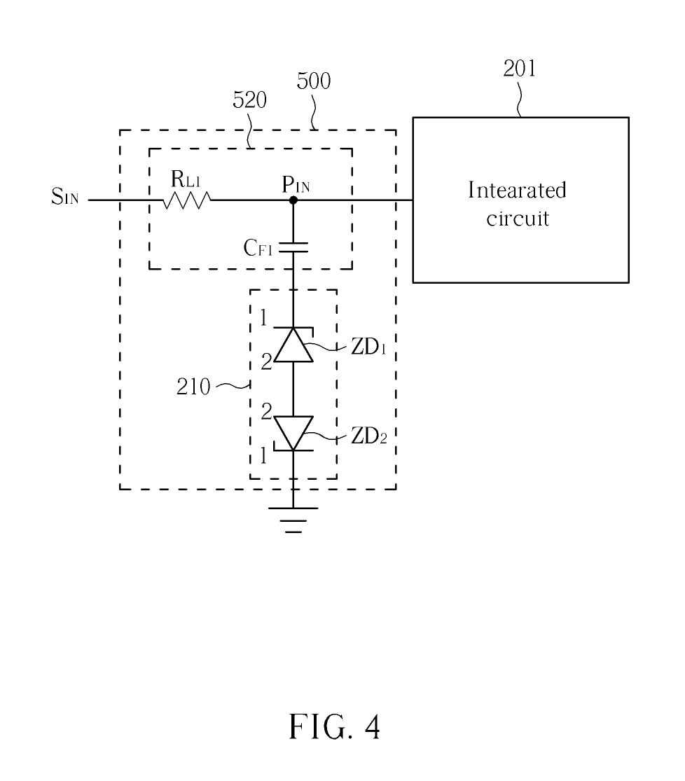

Please refer to FIG. 4, which is a diagram showing a circuit protection system 500 of a third embodiment of the present invention. The circuit protection system 500 comprises the electrostatic discharge protection element 210 and a leakage current protection circuit 520. In contrast to the leakage current protection circuit 220, the current limiting resistor R_{L1} of the leakage current protection circuit 520 is coupled between the signal source Sᵢₙ and the input end Pᵢₙ. The current limiting resistor R_{L1} limits the current magnitude of the input signal to a certain range before the input signal flows to the input end Pᵢₙ. In other words, the current limiting resistor R_{L1} still limits the current magnitude of the input signal to a certain range before the input signal flows into the integrated circuit 201. Therefore, when the input signal comprises leakage current I_{LEAK} generated from the AC power source V_{AC}, the current limiting resistor R_{L1} limits the current magnitude of the leakage current I_{LEAK} before the leakage current I_{LEAK} flows into the integrated circuit 201 in order to protect the integrated circuit 201. Similarly, the current limiting resistors R_{L1} of FIG. 2 and FIG. 4 can coexist to achieve the above function.

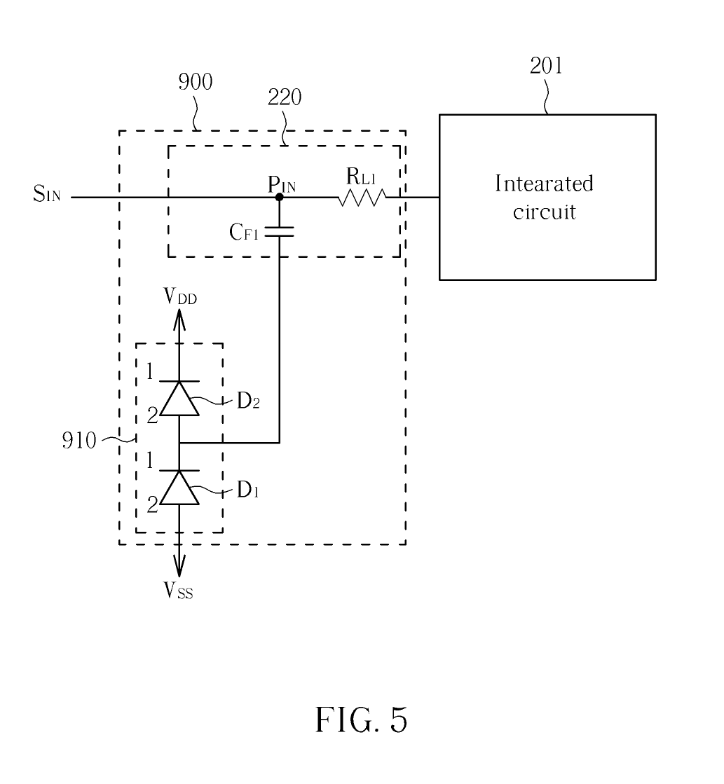

Please refer to FIG. 5, which is a diagram showing a circuit protection system 900 of a fourth embodiment of the present invention. The circuit protection system 900 comprises a electrostatic discharge protection element 910 and the leakage current protection circuit 220 (which is the same as the leakage current protection circuit 220 of FIG. 2). In contrast to the circuit protection system 200, the electrostatic discharge protection element 910 comprises diodes D₁ and D₂. A first end of the diode D₁ is coupled to a second end of the diode D₂, a second end of the diode D₁ is coupled to a voltage source V_{SS}, and a first end of the diode D₂ is coupled to a voltage source V_{DD}. Generally, the voltage source V_{DD} is the voltage source of the integrated circuit 201, and the conductive voltage drop V_{ON} of the diodes D₁ and D₂ is about 0.7V. When the input signal comprises the static electricity, the filter capacitor C_{F1} behaves as a low impedance unit in order to allow the static electricity to flow to the electrostatic discharge protection element 910 from the input end Pᵢₙ. If the voltage level of the static electricity is higher than (V_{DD}+V_{ON}), the diode D₂ will conduct the static electricity to the voltage source V_{DD}. If the voltage level of the static electricity is lower than (V_{SS}−V_{ON}), the diode D₁ will become conductive to eliminate the static electricity. Therefore, the electrostatic discharge protection element 910 can protect the integrated circuit 201 from the static electricity.

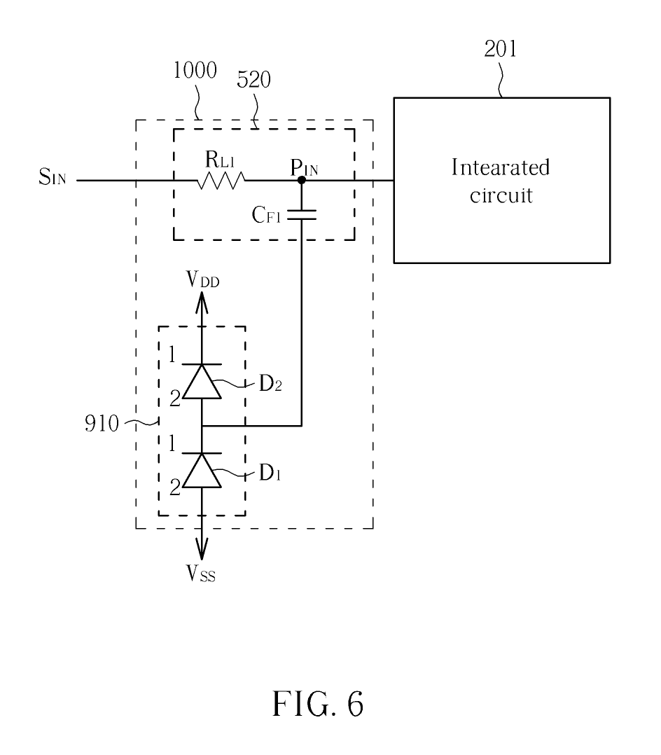

Please refer to FIG. 6, which is a diagram showing a circuit protection system 1000 of a fifth embodiment of the present invention. The current limiting resistors R_{L1} of FIG. 6 work similarly to the current limiting resistors R_{L1} of FIG. 4. In addition, the current limiting resistors R_{L1} of FIG. 5 and FIG. 6 can coexist to achieve the above function.

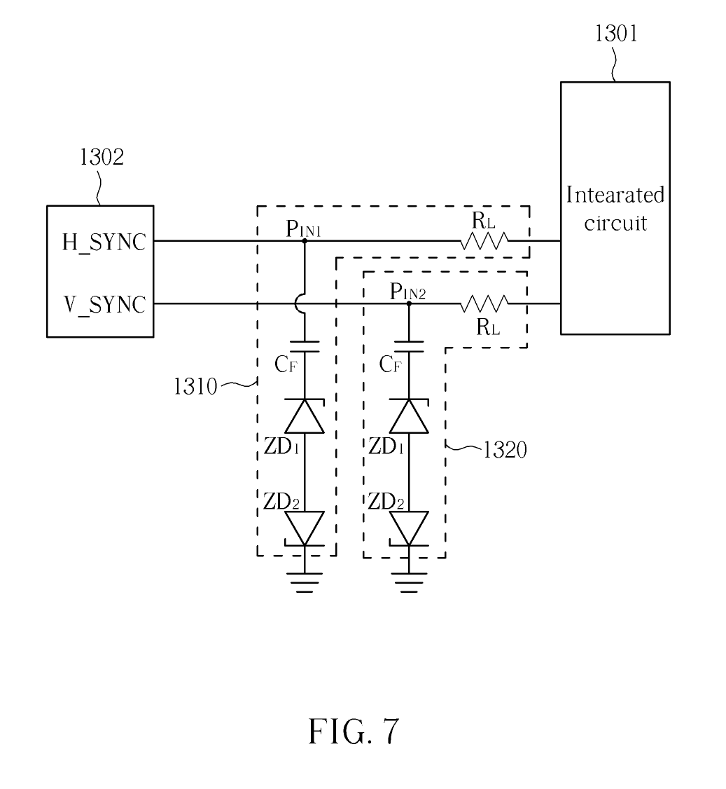

Please refer to FIG. 7, which is a diagram showing a D-sub connector utilizing the circuit protection systems of the present invention. In the embodiment of FIG. 7, the D-sub connector 1302 is coupled between an image source device (for example, a computer) and an integrated circuit 1301 of a projector. The D-sub connector 1302 is coupled to the input ends P_{IN1} and P_{IN2} for transmitting horizontal synchronization signals H_SYNC and vertical synchronization signals V_SYNC to the integrated circuit 1301. The circuit protection systems 1310 and 1320 can protect the integrated circuit 1301 from the static electricity. In addition, the circuit protection systems 1310 and 1320 can also protect the integrated circuit 1301 from the leakage current I_{LEAK}, which may be contained in the horizontal synchronization signals H_SYNC and the vertical synchronization signals V_SYNC transmitted by the D-sub connector 1302.

Those skilled in the art will readily observe that numerous modifications and alterations of the device and method may be made while retaining the teachings of the invention.

What is claimed is:

1. A circuit protection system coupled to an input end of an integrated circuit receiving an input signal from a signal source, the circuit protection system comprising:
an electrostatic discharge protection element; and
a leakage current protection circuit comprising:
a first filter capacitor coupled to the electrostatic discharge protection element, wherein when the input signal comprises leakage current with an ac component, the first filter capacitor behaves as a high impedance unit for preventing the leakage current from passing through the electrostatic discharge protection component, and when the input signal comprises static electricity, the first filter capacitor behaves as a low impedance unit for allowing the static electricity to pass through the electrostatic discharge protection element.

2. The circuit protection system of claim 1 wherein the capacitance of the first filter capacitor ranges from 0.5 μF to 4 μF.

3. The circuit protection system of claim 1 wherein the first filter capacitor and the electrostatic discharge protection element are serially coupled to each other between the input end and a ground end.

4. The circuit protection system of claim 1 wherein the electrostatic discharge protection element comprises:
a first Zener diode having a first end coupled to the input end, and a second end; and
a second Zener diode having a first end coupled to a ground end, and a second end coupled to the second end of the first Zener diode;
wherein the first filter capacitor is coupled between the input end and the first end of the first Zener diode, or between the first end of the second Zener diode and the ground end.

5. The circuit protection system of claim 4 wherein the first filter capacitor is coupled between the input end and the first end of the first Zener diode, and the leakage current protection circuit further comprises a second filter capacitor coupled between the first end of the second Zener diode and the ground end.

6. The circuit protection system of claim 1 wherein the electrostatic discharge protection element comprises:
a first diode having a first end coupled to the input end, and a second end coupled to a first voltage source; and
a second diode having a first end coupled to a second voltage source, and a second end coupled to the first end of the first diode;
wherein the first filter capacitor is coupled to the input end, the first end of the first diode, and the second end of the second diode.

7. The circuit protection system of claim 1 wherein the leakage current protection circuit further comprises a first current limiting resistor coupled between the signal source and the integrated circuit, for limiting current magnitude of the input signal in order to prevent the integrated circuit from being damaged by the leakage current.

8. The circuit protection system of claim 7 wherein the first current limiting resistor is coupled between the input end and the integrated circuit, or between the signal source and the input end.

9. The circuit protection system of claim 8 wherein when the first current limiting resistor is coupled between the input end and the integrated circuit, the leakage current protection circuit further comprises a second current limiting resistor coupled between the signal source and the input end, for limiting current magnitude of the input signal.

10. A circuit protection system coupled to an input end of an integrated circuit receiving an input signal from a signal source, the circuit protection system comprising:
an electrostatic discharge protection element; and
a leakage current protection circuit comprising:
a first filter capacitor coupled to the electrostatic discharge protection element, wherein when the input signal comprises leakage current with an ac component, the first filter capacitor substantially prevents the leakage current from passing through the electrostatic discharge protection component.

11. The circuit protection system of claim 10 wherein the capacitance of the first filter capacitor ranges from 0.5 μF to 4 μF.

12. The circuit protection system of claim 10 wherein the first filter capacitor and the electrostatic discharge protection element are serially coupled to each other between the input end and a ground end.

13. The circuit protection system of claim 10 wherein the electrostatic discharge protection element comprises:
a first Zener diode having a first end coupled to the input end, and a second end; and
a second Zener diode having a first end coupled to a ground end, and a second end coupled to the second end of the first Zener diode;
wherein the first filter capacitor is coupled between the input end and the first end of the first Zener diode, or between the first end of the second Zener diode and the ground end.

14. The circuit protection system of claim 13 wherein the first filter capacitor is coupled between the input end and the first end of the first Zener diode, and the leakage current protection circuit further comprises a second filter capacitor coupled between the first end of the second Zener diode and the ground end.

15. The circuit protection system of claim 10 wherein the electrostatic discharge protection element comprises:
a first diode having a first end coupled to the input end, and a second end coupled to a first voltage source; and
a second diode having a first end coupled to a second voltage source, and a second end coupled to the first end of the first diode;
wherein the first filter capacitor is coupled to the input end, the first end of the first diode, and the second end of the second diode.

16. The circuit protection system of claim 10 wherein the leakage current protection circuit further comprises a first current limiting resistor coupled between the signal source and the integrated circuit, for limiting current magnitude of the input signal in order to prevent the integrated circuit from being damaged by the leakage current.

17. The circuit protection system of claim 16 wherein the first current limiting resistor is coupled between the input end and the integrated circuit, or between the signal source and the input end.

18. The circuit protection system of claim 17 wherein when the first current limiting resistor is coupled between the input end and the integrated circuit, the leakage current protection circuit further comprises a second current limiting resistor coupled between the signal source and the input end, for limiting current magnitude of the input signal.
